(19) United States
(12) Patent Application Publication
(10) Pub. No.: US 2026/0167182 A1
(43) Pub. Date: Jun. 18, 2026

(54) AUTONOMOUS VEHICLE AND METHOD, A PROGRAM, AND A COMPUTER-READABLE RECORDING MEDIUM FOR AVOIDING REAR CROSS-TRAFFIC COLLISION

(71) Applicants: HYUNDAI MOTOR COMPANY, Seoul (KR); KIA CORPORATION, Seoul (KR)

(72) Inventor: Hyung Jun Lim, Hwaseong-si (KR)

(73) Assignees: HYUNDAI MOTOR COMPANY, Seoul (KR); KIA CORPORATION, Seoul (KR)

(21) Appl. No.: 19/325,365

(22) Filed: Sep. 10, 2025

(30) Foreign Application Priority Data
Dec. 17, 2024 (KR) 10-2024-0188831

(51) Int. Cl. B60W 30/09; B60W 30/095; B60W 50/14; B60W 50/16; B60W 60/00

(52) U.S. Cl. CPC B60W 30/09; B60W 30/0956; B60W 50/16; B60W 60/0015; B60W 2050/143; B60W 2050/146; B60W 2420/403; B60W 2420/408; B60W 2520/10; B60W 2554/4044; B60W 2554/806

(57) ABSTRACT

A method of avoiding rear cross-traffic collision of a first vehicle includes: determining a driving status of the first vehicle and determining a risk area based on the driving status of the first vehicle. The method also includes detecting a second vehicle approaching from a rear-cross side of the first vehicle and calculating a target area of the second vehicle. The method additionally includes determining a first intersection of the risk area and the target area and determining whether a second intersection between the first intersection and a warning area on a side of the first vehicle is formed according to movement of the first intersection. The method further includes determining a time of formation of the second intersection and controlling the first vehicle to avoid collision with the second vehicle based on the time of formation of the second intersection.

### CROSS-REFERENCE TO RELATED APPLICATIONS

This application claims the benefit of and priority to Korean Patent Application No. 10-2024-0188831, filed on Dec. 17, 2024, the entire contents of which are hereby incorporated herein by reference.

### BACKGROUND

### Technical Field

The present disclosure relates to an autonomous vehicle, a method, a program, and a computer-readable recording medium for avoiding a rear cross-traffic collision.

### Discussion of the Related Art

Recently released vehicles are being equipped with autonomous driving systems to provide safety for reducing traffic accidents, traffic efficiency on roads, environmental friendliness through fuel savings, and convenience.

Recent autonomous driving systems are technologies that recognize lanes using cameras and perform automatic steering, and measure a lane width, the lateral position of a vehicle in a lane, a distance between lanes, the shape of the lane, and the radius of curvature of a road on the basis of image processing of cameras. In addition, autonomous driving systems also provide functions such as Smart Cruise Control (SCC) that estimates a driving trajectory of a vehicle using measured vehicle locations and road information and changes lanes along the estimated driving trajectory.

A vehicle equipped with such an autonomous driving system can detect a target vehicle approaching from a rear-cross direction, predict a path of the target vehicle, issue a warning to the driver if the path overlaps with the path of the vehicle, and brake the vehicle or change the path of the vehicle without control of the driver, thereby avoiding collision between the vehicle and the target vehicle.

However, even after a target vehicle approaching from the rear-cross direction is detected, there is a possibility of unnecessary warning and braking even if there is no possibility of collision between the vehicle and the target vehicle due to reasons such as a change in the path of the target vehicle and a change in the path of the vehicle.

The statements in this section merely provide background information related to the present disclosure and may not constitute prior art.

### SUMMARY OF THE DISCLOSURE

Embodiments of the present disclosure may detect a second vehicle approaching from a rear-cross direction during autonomous driving of a first vehicle and, when warning and avoidance braking are performed, continuously detect the movement of the second vehicle to prevent unnecessary warning and avoidance braking.

Additional advantages, objects, and features of the disclosure are set forth in part in the following description and in part should become more apparent to those having ordinary skill in the art upon examination of the following description or may be learned from practice of the disclosure. The objectives and other advantages of the disclosure may be realized and attained by the structure particularly pointed out in the written description and the following claims and equivalents thereof as well as the appended drawings.

According to an embodiment, a method for avoiding rear cross-traffic collision of a first vehicle is provided. The method includes determining a driving status of the first vehicle and determining a risk area based on the driving status of the first vehicle. The method also includes detecting a second vehicle approaching from a rear-cross side of the first vehicle and determining a target area of the second vehicle. The method additionally includes determining a first intersection of the risk area and the target area. The method also includes determining whether a second intersection between the first intersection and a warning area on a side of the vehicle is formed according to movement of the first intersection. The method additionally includes determining a time of formation of the second intersection. The method further includes performing warning and controlling of the first vehicle to avoid a collision with the second vehicle based on the time of formation of the second intersection.

Determining the risk area may include diagramming a possible collision area on the rear-cross side of the first vehicle according to driving of the first vehicle.

Determining the target area of the second vehicle may include diagramming a location of the second vehicle approaching from the rear-cross side of the first vehicle with four vertices.

Determining whether the second intersection is formed may include determining whether the second intersection is formed between the first intersection and the warning area on the side of the first vehicle after a certain period of time. The warning area may overlap the risk area and may be located at a front portion of the risk area.

Determining the first intersection may include diagramming an overlapping area of the risk area and the target area.

Determining the time of formation of the second intersection may include determining the time at which the first intersection overlaps the rear of the warning area on the side of the first vehicle.

Determining whether the second intersection is formed may be performed in response to determining that an area of the first intersection increases over time.

In another aspect of the present disclosure, an autonomous vehicle is provided. The autonomous vehicle includes a first sensor configured to collect internal information of the autonomous vehicle. The autonomous vehicle also includes a second sensor configured to collect external information of the autonomous vehicle. The autonomous vehicle further includes an electronic control unit (ECU) configured to control driving of the autonomous vehicle and a human machine interface (HMI) configured to provide output from the ECU to a driver. The ECU is configured to determine a driving status of the autonomous vehicle and determine a risk area based on the driving status of the autonomous vehicle. The ECU is also configured to detect an approaching vehicle, the approaching vehicle approaching from a rear-cross side of the autonomous vehicle. The ECU is further configured to determine a target area of the approaching vehicle and determine a first intersection of the risk area and the target area. The ECU is additionally configured to determine whether a second intersection between the first intersection and a warning area on a side of the autonomous vehicle is formed according to movement of the first intersection and determine a time of formation of the second intersection. The ECU is further configured to warn and control the autonomous vehicle to avoid a collision with the approaching vehicle based on the time of formation of the second intersection.

Another aspect of the present disclosure provides a program recorded on a non-transitory computer-readable recording medium and executed by one or more processors to perform the method of avoiding rear cross-traffic collision of an autonomous vehicle.

Another aspect of the present disclosure provides a non-transitory computer-readable recording medium on which the program is recorded.

It should be understood that both the foregoing general description and the following detailed description of the present disclosure are illustrative and explanatory and are intended to provide a detailed description of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a method of avoiding rear cross-traffic collision of an autonomous vehicle according to an embodiment of the present disclosure;

FIG. 2 is a diagram showing a configuration of an autonomous vehicle according to an embodiment of the present disclosure;

FIG. 3 is a diagram illustrating a positional relationship among a vehicle, a target vehicle, a risk area, a warning area, a first intersection, and a second intersection, according to a first embodiment of the present disclosure; and

FIGS. 4A-5D are diagrams illustrating positional relationships among the vehicle, the target vehicle, the risk area, the warning area, the first intersection, and the second intersection, according to second to seventh embodiments of the present disclosure.

### DETAILED DESCRIPTION

Hereinafter, some embodiments of the present disclosure are described in detail with reference to the accompanying drawings. In adding reference numerals to components in the drawings, it should be noted that the same components are designated with the same reference numerals as much as possible even when the components are shown in different drawings. In addition, in describing embodiments of the present disclosure, where it was determined that a specific description of a related known configuration or function would obscure the gist of the present disclosure, the detailed description thereof has been omitted.

In the description of embodiments according to the present disclosure, a case where an element is described as being formed “on or under” another element includes both a case where the two elements are directly in contact with each other and a case where one or more other elements are formed between the two elements. In addition, the expression of “on or under” may include the meaning of not only the upward direction but also the downward direction based on one element.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus.

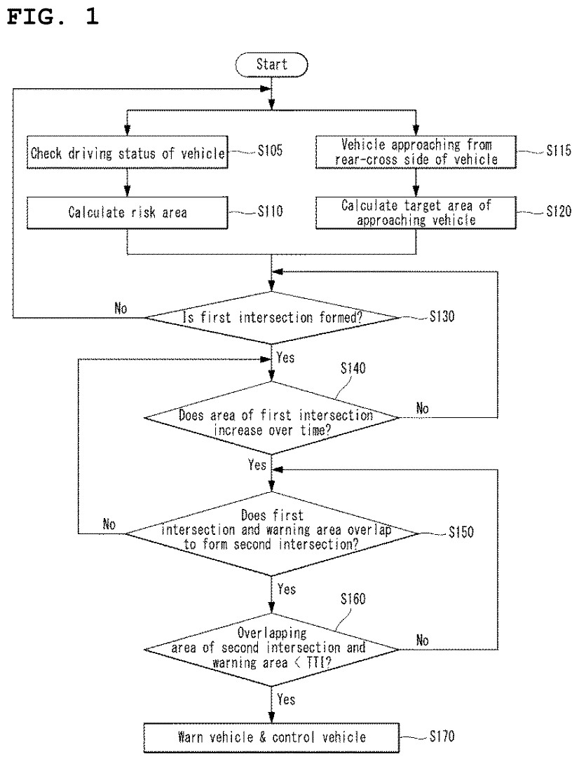

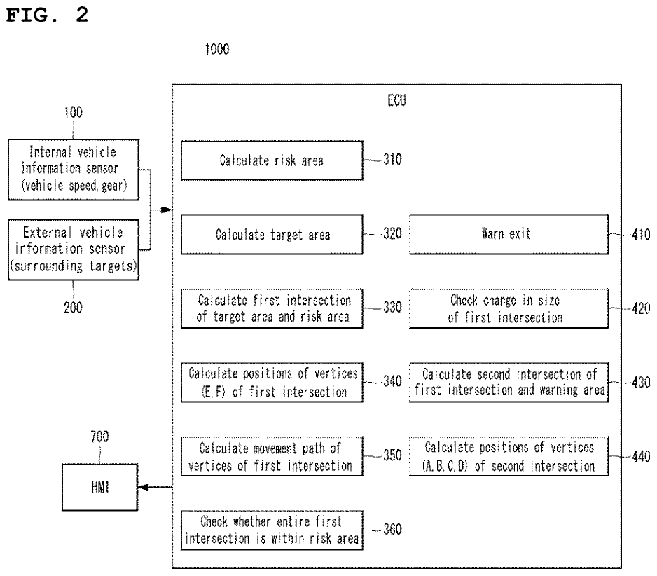

FIG. 1 is a diagram illustrating a method of avoiding rear cross-traffic collision of an autonomous vehicle according to an embodiment of the present disclosure. FIG. 2 is a diagram showing a configuration of an autonomous vehicle according to an embodiment of the present disclosure. Hereinafter, an autonomous vehicle and a method of avoiding rear cross-traffic collision thereof, according to embodiments, are described in more detail with reference to FIGS. 1 and 2.

Referring first to FIG. 2, an autonomous vehicle 1000 according to an embodiment of the present disclosure includes a first sensor 100, a second sensor 200, and a human machine interface (HMI) 700. The first senor 100 may be an internal vehicle information sensor that detects a vehicle speed, gear, or the like. The second sensor 200 may be an external vehicle information sensor that detects surrounding targets. The human machine interface (HMI) 700 may transmit output from an electronic control unit (ECU).

Referring now to FIG. 1, in an operation S105, a driving status of a vehicle (e.g., the vehicle 1000; sometimes referred herein as “first vehicle”) may be checked or otherwise determined, and, in an operation S110, a risk area may be determined (e.g., calculated). Determining the driving status of the vehicle may include checking or otherwise determining the current location of the vehicle. Determining the “risk area” may include diagramming an area where there is a possibility of collision with a vehicle (sometimes referred to herein as “second vehicle”) approaching from the rear-cross side of the current location of the vehicle as a “risk area”. The risk area may be diagramed as a rectangular shape with four vertices, for example.

In an operation S115, a vehicle approaching from the rear-cross side of the vehicle is detected. In an operation S120, a target area of the approaching vehicle is determined (e.g., calculated). The vehicle approaching from the rear-cross side may include not only four-wheeled vehicles such as large trucks including containers or passenger cars, but also two-wheeled vehicles such as bicycles. In the following description, a four-wheeled vehicle is described as an example for illustrative purposes.

The aforementioned approaching vehicle may also be referred to as a target vehicle. In an embodiment, the length of the target vehicle may be from a minimum of 1 meter to a maximum of 16 meters, and the width of the target vehicle may be from 0.7 meters to 3.7 meters.

In an example, the location of a target vehicle approaching from the rear-cross side of the vehicle may be diagrammed as a rectangular shape with four vertices.

In an operation S130, an overlapping area of the risk area and the target area may be diagrammed to obtain an intersection. This intersection may be referred to as a “first intersection”. Thus, in the operation S130, it may be determined whether a first intersection is formed by an overlap between the risk area and the target area.

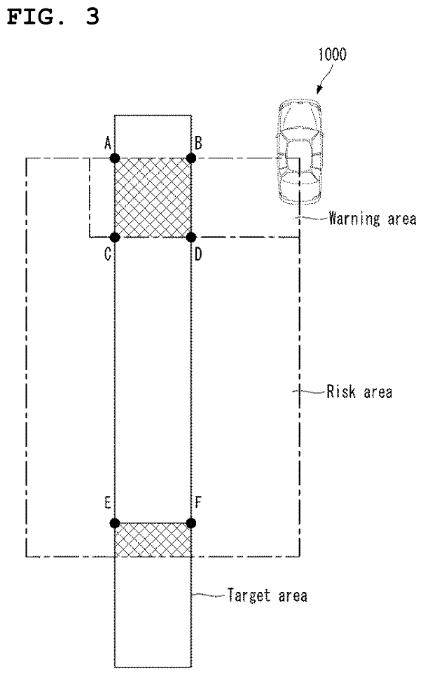

FIG. 3 illustrates the first intersection where the risk area on the rear-cross side of the vehicle and the target area of the target vehicle overlap, according to an embodiment. A “warning area” and the “risk area” are indicated by dotted lines, and the movement path of the target vehicle is indicated by a solid line. In FIG. 3, a part of the target area overlaps with the risk area to form the first intersection. The frontmost part of the first intersection is indicated in FIG. 3 by two vertices (E, F). The hatched area from the two vertices (E, F) to the boundary line of the risk area corresponds to the first intersection.

Referring again to FIG. 1, if it is determined that the first intersection is not formed (No in the operation S130), for example if the target vehicle is not detected at the rear of the vehicle, operations S105 and S115 are performed again.

On the other hand, if it is determined that the first intersection is formed (Yes in the operation S130), it is determined, in an operation S140, whether the area of the first intersection increases over time (or remains the same). If it is determined that the area of the first intersection increases over time or remains the same (Yes in the operation S140), it may be determined that the target vehicle enters the risk area, as described in more detail below, or continues to remain within the risk area, and thus it may be determined whether there is an actual possibility of collision between the vehicle and the target vehicle.

On the other hand, if it is determined that the area of the first intersection decreases over time (No in the operation S140), it may be determined that the target vehicle leaves the risk area, and thus the above-described operation S130 may be continued.

In addition, if it is determined that the area of the first intersection increases over time or remains the same (Yes in the operation S140), this may indicate that the first intersection moves according to movement of the target vehicle after a certain period of time, and thus, in an operation S150, it may be determined whether a second intersection is formed between the first intersection and the warning area on the rear-cross side of the vehicle.

The movement of the first intersection may refer to a path along which the target vehicle moves over time. The movement of the first intersection may be predicted by measuring the moving speed and acceleration of the target vehicle through the external sensor 200 of the vehicle. The “warning area” on the rear-cross side of the vehicle may refer to an area where there is a risk of collision with the vehicle when the target vehicle approaches from the rear-cross side of the vehicle, as shown in FIG. 3. The “warning area” overlaps with the “risk area” described above and may be located at the front of the “risk area”.

The warning area may be changed by the movement of the vehicle over time. The warning area may be determined based on, for example, the speed, yaw, and rotation curvature of the vehicle. In an example, the warning area may be set on the side of a first position by determining the first position to which the vehicle will move from the current location after a first time has elapsed.

Yawing of the vehicle refers to a phenomenon in which the vehicle rotates and vibrates about the vertical axis. The first position and warning area to which the vehicle will move after the first time has elapsed may be set based on the current speed of the vehicle, yaw, and rotation curvature of the vehicle.

FIG. 3 illustrates the movement path of the target vehicle over time. The target vehicle moves forward to form the second intersection with the “risk area”, and the second intersection is a rectangle defined by four vertices (A, B, C, D).

Referring again to FIG. 1, if it is determined that the second intersection is not formed (No in the operation S150), the above-described step S140 may be continued upon determining that there is no possibility of the vehicle actually colliding with the target vehicle.

On the other hand, if it is determined that the second intersection is formed (Yes in the operation S150), the time of forming of the second intersection is calculated to warn the vehicle and control the vehicle in an operation S170. Referring to FIG. 3, TTI (Time to Intersection) is the time when the two front vertices (A, B) among the four vertices forming the second intersection overlap the risk area. In an operation S160, the TTI may be determined (e.g., calculated) and, further, it may be determined whether the TTI is less than a preset time. If it is determined that the TTI is lea than the preset time (Yes in the operation S160), it may be determined that there is a possibility of collision between the vehicle and the target vehicle.

In an embodiment, the preset time may be a time at which braking should be started in consideration of the braking performance of the vehicle to avoid collision between the vehicle and the target vehicle. The present time may be, for example, 2.7 seconds. The method of warning the vehicle is performed through the HMI 700, and may include visual display on the cluster, auditory warning such as sounding a warning sound inside the vehicle, and/or a tactile method through vibration of the steering wheel. Starting braking may include changing lanes in the opposite direction to the warning area, stopping the vehicle from changing lanes to the warning area, and accelerating the vehicle.

On the other hand, if it is determined that the TTI is longer than the preset time (No in the operation S160), the operation S160 may be continued upon determining that there is no possibility of the vehicle colliding with the target vehicle.

Setting of the above-described target area, setting of the risk area and the warning area for the vehicle, and detection of the first and second intersections may be performed by the ECU of the vehicle. The ECU operates as a control unit of the autonomous vehicle. Referring to FIG. 2, the ECU may perform functions or operations, including a function or operation 310 of calculating a risk area, a function or operation 320 of calculating a target area, a function or operation 330 of calculating the first intersection of the target area and the risk area, an operation 340 of calculating the positions of vertices (E, F) of the first intersection, a function or operation 350 of calculating movement paths of the vertices of the first intersection, a function or operation 360 of checking whether the entire first intersection is within the risk area, a function or operation 410 of issuing an exit warning, a function or operation 420 of checking a change in the size of the first intersection, a function or operation 430 of calculating the second intersection of the first intersection and the risk area, and a function or operation 440 of calculating the positions of the vertices (A, B, C, D) of the second intersection. In an embodiment, the functions or operations performed by the ECU are the same as described above. In an embodiment, the exit warning function 410 detects a target vehicle approaching from the rear-cross side when the driver and passengers of the vehicle attempt to open the door to alight, and issues a warning when the target vehicle approaches in the direction of the door.

In the first embodiment illustrated in FIG. 3, the target area of the target vehicle partially overlaps the rear of the risk area of the vehicle 1000 to form the first intersection, the two vertices (E, F) at the frontmost of the first intersection are indicated, the driving path of the target vehicle indicated by a solid line overlaps the warning area to form the second intersection, and the second intersection is defined by four vertices (A, B, C, D).

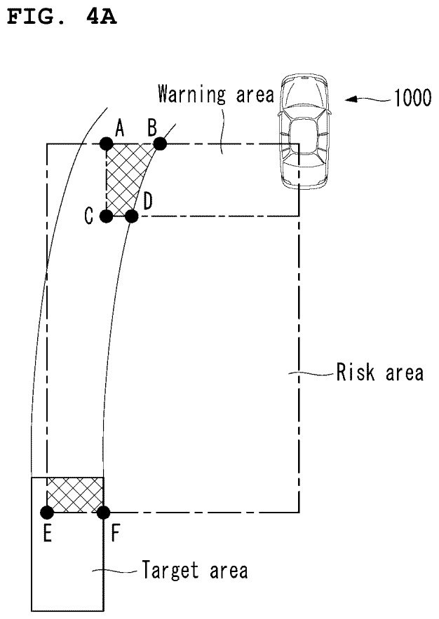

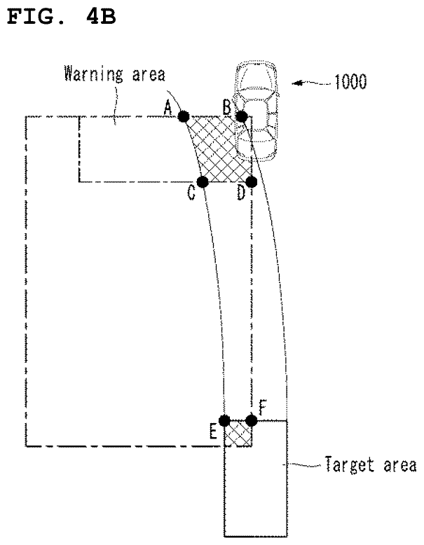

In a second embodiment illustrated in FIG. 4A, if the target vehicle were moving straight, it would not meet the warning area of the vehicle 1000, but since the target vehicle actually moves around a curve, the area of the first intersection gradually expands and overlaps with the warning area to form the second intersection. Therefore, before forming the second intersection, the area of the first intersection gradually expands, and thus it is possible to warn and control the vehicle.

In a third embodiment illustrated in FIG. 4B, if the target vehicle were moving straight, it would collide with the rear area of the warning area of the vehicle 1000, but since the target vehicle actually moves around a curve, the area of the first intersection gradually expands and overlaps with the warning area to form the second intersection. Therefore, before forming the second intersection, the area of the first intersection gradually expands, and thus it is possible to warn and control the vehicle.

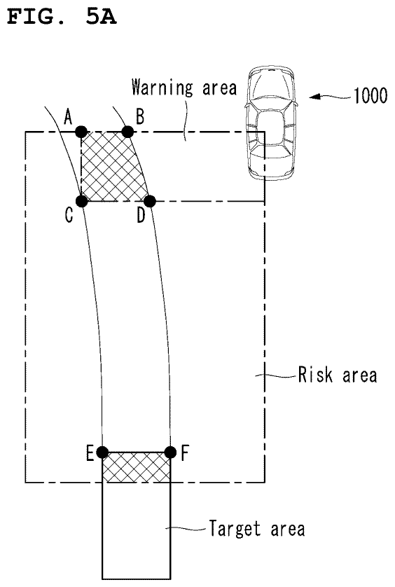

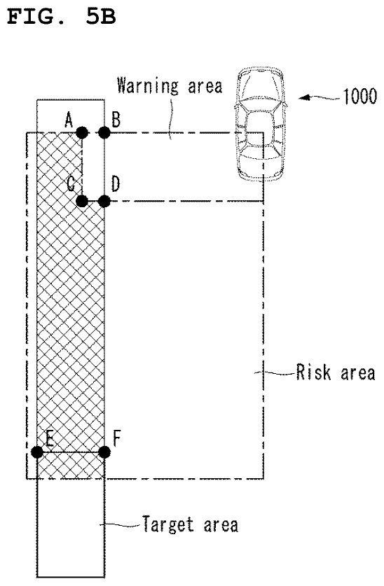

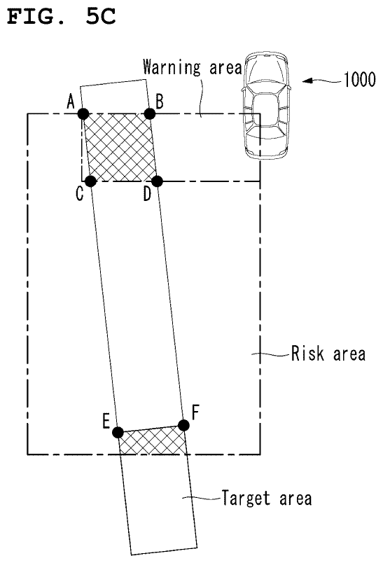

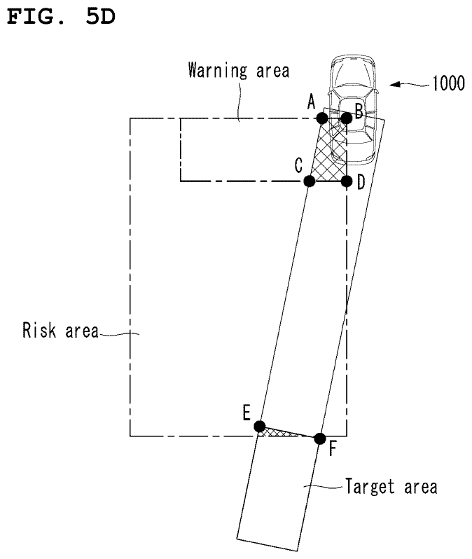

In a fourth embodiment illustrated in FIG. 5A, the direction of travel of the target vehicle forms a curve, and if the target vehicle were moving straight, it would not meet the warning area of the vehicle 1000. However, the target vehicle actually moves around a curve, and the area of the first intersection is constant, but as the target vehicle moves to the left, the area of the predicted second intersection is gradually reduced. Therefore, warning and control may not be performed on the vehicle. However, if the vehicle 1000 moves backwards or changes lanes to the left, it is possible to warn and control the vehicle.

In a fifth embodiment illustrated in FIG. 5B, if the target vehicle were moving straight, it would meet the warning area of the vehicle 1000 in a relatively narrow area to form the second intersection. Therefore, it is possible to warn and control the vehicle, but if the vehicle 1000 does not change lanes to the left or does not move backwards, warning and control may not be performed on the vehicle.

In a sixth embodiment illustrated in FIG. 5C, the direction of travel of the target vehicle is a straight line and gradually moves away from the vehicle 1000. Therefore, if the target vehicle were moving straight, it would meet the warning area of the vehicle 1000. Further, the area of the first intersection is constant, but as the target vehicle moves to the left, the area of the predicted second intersection is gradually reduced. Therefore, warning and control may not be performed on the vehicle. However, if the vehicle 1000 moves backwards or changes lanes to the left, it is possible to warn and control the vehicle.

In a seventh embodiment illustrated in FIG. 5D, the direction of travel of the target vehicle is a straight line and is gradually approaching the vehicle 1000. Therefore, if the target vehicle moves straight, the target vehicle can directly meet the warning area of the vehicle 1000 and the rear of the vehicle. The area of the first intersection gradually decreases, but since the second intersection is formed at the rear of the vehicle 1000, it is expected that the target vehicle and the vehicle will collide. Accordingly, it is possible to warn and control the vehicle.

According to the autonomous vehicle, the method of avoiding rear cross-traffic collision thereof, the program, and the computer-readable recording medium according to embodiments of the present disclosure described above, it is possible to warn of a possibility of collision with a target vehicle approaching from a rear-cross direction and avoid the collision while preventing unnecessary warning and avoidance control by setting the first intersection between a target area of the target vehicle and a risk area and setting the second intersection where the first intersection can actually collide with the rear-cross side of the vehicle.

In the above, even though all the components constituting the embodiments of the present disclosure have been described as being combined as one or operating in combination, the present disclosure is not necessarily limited to these embodiments. For example, within the scope of the purpose of the present disclosure, one or more of the components may be selectively combined and operated. In addition, the term “comprise”, “include”, or “have” described herein should be interpreted not to exclude other elements but to further include such other elements since the corresponding elements may be included unless mentioned otherwise. All terms including technical or scientific terms have the same meanings as generally understood by a person having ordinary skill in the art to which the present disclosure pertains unless specifically described herein otherwise. Generally used terms, such as terms defined in a dictionary, should be interpreted to coincide with meanings of the related art from the context. Unless differently defined in the present disclosure, such terms should not be interpreted in an ideal or excessively formal manner.

The above description is merely an illustrative description of the technical idea of the present disclosure, and those having ordinary skill in the art to which the present disclosure pertains may make various modifications and variations without departing from the essential characteristics of the present disclosure. Accordingly, the embodiments of the present disclosure are not intended to limit the technical idea of the present disclosure but to explain the same, and the scope of the technical idea of the present disclosure is not limited by these embodiments. The scope of protection of the present disclosure should be interpreted by the following claims, and all technical ideas within the equivalent scope should be interpreted as being included in the scope of the rights of the present disclosure.

What is claimed is:

1. A method of avoiding rear cross-traffic collision of a first vehicle, the method comprising:
determining a driving status of the first vehicle;
determining a risk area based on the driving status of the first vehicle;
detecting a second vehicle approaching from a rear-cross side of the first vehicle;
determining a target area of the second vehicle;
determining a first intersection of the risk area and the target area;
determining whether a second intersection between the first intersection and a warning area on a side of the first vehicle is formed according to movement of the first intersection;
determining a time of forming of the second intersection; and
performing warning and control of the first vehicle to avoid a collision with the second vehicle based on the time of forming of the second intersection.

2. The method of claim 1, wherein determining the risk area includes diagramming a collision area on the rear-cross side of the first vehicle according to driving of the first vehicle.

3. The method of claim 1, wherein determining the target area of the second vehicle includes diagramming a location of the second vehicle approaching from the rear-cross side of the first vehicle with four vertices.

4. The method of claim 3, wherein determining whether the second intersection is formed includes determining whether the second intersection is formed between the first intersection and the warning area on the side of the vehicle after a certain period of time, wherein the warning area overlaps the risk area and is located at a front portion of the risk area.

5. The method of claim 1, wherein determining the first intersection includes diagramming an overlapping area of the risk area and the target area.

6. The method of claim 1, wherein determining the time of forming of the second intersection includes determining a time at which the first intersection is formed to overlap a rear portion of the warning area on the side of the first vehicle.

7. The method of claim 1, wherein determining whether the second intersection is formed is performed in response to determining that an area of the first intersection increases over time.

8. An autonomous vehicle comprising:
a first sensor configured to collect internal information of the autonomous vehicle;
a second sensor configured to collect external information of the autonomous vehicle;
an electronic control unit (ECU) configured to control driving of the autonomous vehicle; and
a human machine interface (HMI) configured to provide output from the ECU to a driver,
wherein the ECU is configured to:
determine a driving status of the autonomous vehicle,
calculates a risk area based on the driving status of the autonomous vehicle,
detect an approaching vehicle, the approaching vehicle approaching from a rear-cross side of the autonomous vehicle,
determine a target area of the approaching vehicle,
determine a first intersection of the risk area and the target area,
determine whether a second intersection between the first intersection and a warning area on a side of the autonomous vehicle is formed according to movement of the first intersection,
determine a time of forming of the second intersection, and
warn and control the autonomous vehicle to avoid a collision with the approaching vehicle based on the time of forming of the second intersection.

9. The autonomous vehicle of claim 8, wherein the ECU is configured to determine the risk area by diagramming a collision area on the rear-cross side of the autonomous vehicle according to driving of the autonomous vehicle.

10. The autonomous vehicle of claim 8, wherein the ECU is configured to determine the target area of the approaching vehicle by diagramming a location of the approaching vehicle approaching from the rear-cross side of the autonomous vehicle with four vertices.

11. The autonomous vehicle of claim 10, wherein the ECU is configured to determine whether the second intersection is formed by determining whether the second intersection is formed between the first intersection and the warning area on the side of the autonomous vehicle after a certain period of time, and
wherein the warning area overlaps the risk area and is located at a front portion of the risk area.

12. The autonomous vehicle of claim 8, wherein the ECU is configured to determine the first intersection by diagramming an overlapping area of the risk area and the target area.

13. The autonomous vehicle of claim 8, wherein the ECU is configured to determine the time of formation of the second intersection by calculating a time at which the first intersection is formed to overlap a rear portion of the warning area on the side of the autonomous vehicle.

14. The autonomous vehicle of claim 8, wherein the ECU is configured to determine whether the second intersection is formed in response to determining that an area of the first intersection increases over time.

15. A non-transitory computer-readable recording medium storing instructions that, when executed by one or more processors, cause the one or more processors to:
determine a driving status of a first vehicle;
determine a risk area based on the driving status of the first vehicle;
detect a second vehicle approaching from a rear-cross side of the first vehicle;
determine a target area of the second vehicle;
determine a first intersection of the risk area and the target area;
determine whether a second intersection between the first intersection and a warning area on a side of the first vehicle is formed according to movement of the first intersection;
determine a time of forming of the second intersection; and
perform warning and control of the first vehicle based on the time of forming of the second intersection.

16. The non-transitory computer-readable recording medium of claim 15, wherein the instructions, when executed by the one or more processors, cause the one or more processors to determine the risk area by diagramming a collision area on the rear-cross side of the first vehicle according to driving of the first vehicle.

17. The non-transitory computer-readable recording medium of claim 15, wherein the instructions, when executed by the one or more processors, cause the one or more processors to determine the target area of the approaching vehicle by diagramming a location of the approaching vehicle approaching from the rear-cross side of the first vehicle with four vertices.

18. The non-transitory computer-readable recording medium of claim 15, wherein the instructions, when executed by the one or more processors, cause the one or more processors to determine whether the second intersection is formed by determining whether the second intersection is formed between the first intersection and the warning area on the side of the first vehicle after a certain period of time,
wherein the warning area overlaps the risk area and is located at a front portion of the risk area.

19. The non-transitory computer-readable recording medium of claim 15, wherein the instructions, when executed by the one or more processors, cause the one or more processors to determine the first intersection by diagramming an overlapping area of the risk area and the target area.

20. The non-transitory computer-readable recording medium of claim 15, wherein the instructions, when executed by the one or more processors, cause the one or more processors to determine the time of formation of the second intersection by calculating a time at which the first intersection is formed to overlap a rear portion of the warning area on the side of the first vehicle.
